(19) United States
(12) Patent Application Publication
(10) Pub. No.: US 2006/0285465 A1
(43) Pub. Date: Dec. 21, 2006

(54) Information recording processing device, information reproduction processing device, information recording medium and method, and computer program

(76) Inventors: Tsutomu Ichinose, Tochigi (JP); Shunsuke Furukawa, Tokyo (JP); Takuya Wada, Tokyo (JP)

Correspondence Address: BELL, BOYD & LLOYD, LLC, P. O. BOX 1135, CHICAGO, IL, 60690-1135, US

(21) Appl. No.: 10/569,009

(22) PCT Filed: Sep. 1, 2004
(86) PCT No.: PCT/JP04/12656

§ 371 Date: Feb. 21, 2006

(30) Foreign Application Priority Data
Sep. 11, 2003 (JP) 2003-319591

(51) Int. Cl. G11B 7/00; G11B 20/12

(52) U.S. Cl. 369/53.31; 369/59.25

(57) ABSTRACT

A device, a medium, and a method for recording and reproducing additional data difficult to analyze on an information recording medium are provided. When additional data is recorded onto the information recording medium, or additional data such for example as key information applied to a content decryption process, content reproduction control information, or copy control information is recorded on the information recording medium, the parity of a data-changeable data unit, for example user control data (UCD) is set to even parity or odd parity by controlling constituent bits of the user control data according to constituent bit information [0] or [1] of the additional data and according to whether the parity of a specific additional data-corresponding recording frame selected is even parity or odd parity. At a time of reproduction, the additional constituent bit information [0] or [1] is obtained by detecting the parity of the additional data-corresponding recording frame and the parity of the constituent data of the user control data (UCD).

### TECHNICAL FIELD

The present invention relates to an information recording processing device, an information reproduction processing device, an information recording medium and a method, and a computer program. More particularly, the present invention relates to an information recording processing device, an information reproduction processing device, an information recording medium and a method, and a computer program that make it possible to record and read additional information, or various additional information such for example as key information applied to a content decryption process, content reproduction control information, or copy control information on an information recording medium on which contents such for example as image data and music data are recorded in a mode difficult to analyze by a combination of a characteristic of controllable data such as user control information or the like that does not affect actual data such as the contents or the like and a characteristic of specific recording data (recording frame).

### BACKGROUND ART

When data such as music data, image data and the like is recorded as digital data onto a recording medium, a recording process is performed according to a predetermined recording format. For example, an error detecting/correcting code is added to original data to be recorded, and the data is converted (coding) into a format corresponding to a specific data recording and reproduction process and then recorded.

A system has recently been developed which records and reproduces information using a blue laser as an information recording medium allowing high-density information recording. In an information recording process using this blue laser, a modulating process is performed which basically modulates two-bit data into three-bit data.

There are movies, music data and the like as contents stored on such an information recording medium. A distribution right or the like to many contents such as music data, image data and the like is generally held by a creator or a seller of the contents. Thus, generally, in distributing these contents, a certain use limitation is set, that is, only authorized users are permitted to use the contents so that unauthorized copying or the like is prevented.

Data of one to several movies, for example, can be recorded on a single high-capacity type recording medium such for example as a recording medium using a blue laser recording system allowing high-capacity recording. As contents can be thus recorded easily as digital information, a problem of a flood of unauthorized copies frequently occurs, and therefore a problem of impaired interests of holders of content copyrights and distribution rights is becoming more serious. Because of such a present situation, prevention of unauthorized copying and protection of interests of holders of content copyrights and distribution rights are an important challenge.

In order to prevent such unauthorized use of contents, a constitution is proposed in which contents stored on an information recording medium are recorded as encrypted contents, and encryption key information applied to use of the encrypted contents, information necessary to generate an encryption key, or various control information for content reproduction control, copy control and the like is stored as secret information on the information recording medium. A reproduction processing program executed in a reproducing device of a user reads secret information such as a key or the like corresponding to contents to be reproduced, decrypts the contents according to the read secret information, and allows the contents to be used according to reproduction control information.

As a conventional technique in which a secret information embedding process constitution is disclosed, (see Japanese Patent Laid-open No. 2003-45128 as Patent Document 1), for example, discloses a constitution that embeds special data by using connection bits (margin bits) of EFM modulated data. Japanese Patent Laid-open No. 2002-367282 as Patent Document 2 discloses a constitution in which a plurality of conversion tables are applied in a modulating process, and at a time of reproduction, data on a conversion table applied in modulation is extracted and additional data is obtained on the basis of the extracted data.

However, when information indicating where such an encryption key or control information is stored on an information recording medium is obtained by a user or an unauthorized contents user, the additional information can be leaked or altered. For example, a problem of alteration of reproduction control information and copy control information or leakage of key information occurs. When key information is leaked or control information is altered, a form of use of contents which form is based on legitimate rights to use the contents collapses, and copyrights and distribution rights of the contents are not fully protected.

### DISCLOSURE OF INVENTION

The present invention has been made in view of the above problems, and it is an object of the present invention to provide an information recording processing device, an information reproduction processing device, an information recording medium and a method, and a computer program that make it possible to record various information such for example as an encryption key, encryption key generating information, content reproduction control information, content copy control information, or other content attribute information stored on a recording medium together with contents in a mode that makes it impossible to read the additional information by a general data reading process, and make unauthorized data reading difficult.

More specifically, it is an object of the present invention to provide an information recording processing device, an information reproduction processing device, an information recording medium and a method, and a computer program that enable recording and reading in a mode difficult to analyze by a combination of a characteristic of controllable data such as user control information or the like that does not affect actual data such as contents or the like and a characteristic of specific recording data (recording frame).

According to a first aspect of the present invention, there is provided an information recording processing device characterized by including: a modulated data generating unit for generating a modulated recording frame by performing data modulation processing on data to be recorded; recording frame characteristic determining means for determining a data characteristic of constituent data of an additional data-corresponding recording frame; and an additional data-corresponding data controlling unit for controlling constituent bits of a data-changeable data part on a basis of a constituent bit value of additional data and the data characteristic of the constituent data of the additional data-corresponding recording frame.

Further, in an embodiment of the information recording processing device according to the present invention, in the additional data-corresponding data controlling unit, the data part whose constituent bits are controlled is user control data (UCD).

Further, in an embodiment of the information recording processing device according to the present invention, the data characteristic of the constituent data of the additional data-corresponding recording frame is a characteristic of whether parity of the constituent data of the recording frame is even parity or odd parity, and the additional data-corresponding data controlling unit controls the constituent bits of the data-changeable data part on a basis of two conditions of whether the constituent bit value of the additional data is 0 or 1 and whether the parity of the constituent data of the additional data-corresponding recording frame is even parity or odd parity.

Further, in an embodiment of the information recording processing device according to the present invention, the additional data-corresponding data controlling unit performs control to set parity of the data-changeable data part to one of odd parity and even parity.

Further, in an embodiment of the information recording processing device according to the present invention, the information recording processing device sets the additional data as constituent information of at least one of encryption key information, encryption key generating information, content reproduction control information, and content copy control information for contents stored on the information recording medium.

Further, in an embodiment of the information recording processing device according to the present invention, the modulated data generating unit generates the modulated recording frame by performing a data conversion process satisfying RLL (1, 7) as a run length rule.

Further, in an embodiment of the information recording processing device according to the present invention, the modulated data generating unit performs a modulated recording frame generating process including a process of conversion of two-bit information into three-bit information.

Further, according to a second aspect of the present invention, there is provided an information reproduction processing device for reproducing information stored on an information recording medium, the information reproduction processing device characterized by including: a demodulating unit for demodulating data read from the information recording medium; and an additional data decoding unit for determining data characteristics of an additional data-corresponding recording frame and specific user control data read from the information recording medium, and obtaining additional data constituent bit information on a basis of the two determined data characteristics.

Further, in an embodiment of the information reproduction processing device according to the present invention, in the additional data decoding unit, a data part whose data characteristic is determined is user control data (UCD).

Further, in an embodiment of the information reproduction processing device according to the present invention, the data characteristic of constituent data of the additional data-corresponding recording frame is a characteristic of whether parity of the constituent data of the recording frame is even parity or odd parity, and the additional data decoding unit obtains the additional data constituent bit information on a basis of two data characteristic determinations of whether the parity of the constituent data of the additional data-corresponding recording frame is even parity or odd parity and whether parity of constituent data of the specific user control data is even parity or odd parity.

Further, in an embodiment of the information reproduction processing device according to the present invention, the information reproduction processing device generates at least one of encryption key information, encryption key generating information, content reproduction control information, and content copy control information for contents stored on the information recording medium on a basis of the obtained additional data constituent bit information.

Further, according to a third aspect of the present invention, there is provided an information recording medium characterized by storing: modulated data based on a plurality of recording frames; and user control data having a data characteristic determined on a basis of a constituent bit value of additional data and a data characteristic of constituent data of a specific additional data-corresponding recording frame selected from the plurality of recording frames.

Further, in an embodiment of the information recording medium according to the present invention, the data characteristic of the constituent data of the additional data-corresponding recording frame is a characteristic of whether parity of the constituent data of the recording frame is even parity or odd parity, and the user control data has the data characteristic determined according to two conditions of whether the constituent bit value of the additional data is 0 or 1 and whether the parity of the constituent data of the additional data-corresponding recording frame is even parity or odd parity.

Further, in an embodiment of the information recording medium according to the present invention, the data characteristic determined for the user control data is a data characteristic of whether parity of constituent data of the user control data is even parity or odd parity, and the user control data having the parity determined on a basis of the constituent bit value of the additional data and the data characteristic of the constituent data of the specific additional data-corresponding recording frame selected from the plurality of recording frames is stored.

Further, in an embodiment of the information recording medium according to the present invention, the information recording medium stores the additional data as constituent information of at least one of encryption key information, encryption key generating information, content reproduction control information, and content copy control information for contents stored on the information recording medium.

Further, in an embodiment of the information recording medium according to the present invention, the data based on a modulated recording frame generated by performing a data conversion process satisfying RLL (1, 7) as a run length rule is recorded on the information recording medium.

Further, in an embodiment of the information recording medium according to the present invention, the data based on a modulated recording frame generated by performing a process of converting two-bit information into three-bit information is recorded on the information recording medium.

Further, according to a fourth aspect of the present invention, there is provided an information recording processing method characterized by including: an additional data-corresponding data controlling step of controlling constituent bits of a data-changeable data part on a basis of a constituent bit value of additional data and a data characteristic of constituent data of an additional data-corresponding recording frame; and a modulated data generating step of generating a modulated recording frame by performing data modulation processing on data to be recorded.

Further, in an embodiment of the information recording processing method according to the present invention, in the additional data-corresponding data controlling step, the data part whose constituent bits are controlled is user control data (UCD).

Further, in an embodiment of the information recording processing method according to the present invention, the data characteristic of the constituent data of the additional data-corresponding recording frame is a characteristic of whether parity of the constituent data of the recording frame is even parity or odd parity, and the additional data-corresponding data controlling step controls the constituent bits of the data-changeable data part on a basis of two conditions of whether the constituent bit value of the additional data is 0 or 1 and whether the parity of the constituent data of the additional data-corresponding recording frame is even parity or odd parity.

Further, in an embodiment of the information recording processing method according to the present invention, the additional data-corresponding data controlling step performs control to set parity of the data-changeable data part to one of odd parity and even parity.

Further, in an embodiment of the information recording processing method according to the present invention, the additional data in the information recording processing method is constituent information of at least one of encryption key information, encryption key generating information, content reproduction control information, and content copy control information for contents stored on the information recording medium.

Further, in an embodiment of the information recording processing method according to the present invention, the modulated data generating step generates the modulated recording frame by performing a data conversion process satisfying RLL (1, 7) as a run length rule.

Further, in an embodiment of the information recording processing method according to the present invention, the modulated data generating step performs a modulated recording frame generating process including a process of conversion of two-bit information into three-bit information.

Further, according to a fifth aspect of the present invention, there is provided an information reproduction processing method for reproducing information stored on an information recording medium, the information reproduction processing method characterized by including: a demodulating step of demodulating data read from the information recording medium; and an additional data decoding step of determining data characteristics of an additional data-corresponding recording frame and specific user control data read from the information recording medium, and obtaining additional data constituent bit information on a basis of the two determined data characteristics.

Further, in an embodiment of the information reproduction processing method according to the present invention, in the additional data decoding step, a data part whose data characteristic is determined is user control data (UCD).

Further, in an embodiment of the information reproduction processing method according to the present invention, the data characteristic of constituent data of the additional data-corresponding recording frame is a characteristic of whether parity of the constituent data of the recording frame is even parity or odd parity, and the additional data decoding step obtains the additional data constituent bit information on a basis of two data characteristic determinations of whether the parity of the constituent data of the additional data-corresponding recording frame is even parity or odd parity and whether parity of constituent data of the specific user control data is even parity or odd parity.

Further, in an embodiment of the information reproduction processing method according to the present invention, the information reproduction processing method further includes a step of generating at least one of encryption key information, encryption key generating information, content reproduction control information, and content copy control information for contents stored on the information recording medium on a basis of the obtained additional data constituent bit information.

Further, according to a sixth aspect of the present invention, there is provided a computer program for performing an information recording process, the computer program characterized by including: an additional data-corresponding data controlling step of controlling constituent bits of a data-changeable data part on a basis of a constituent bit value of additional data and a data characteristic of constituent data of an additional data-corresponding recording frame; and a modulated data generating step of generating a modulated recording frame by performing data modulation processing on data to be recorded.

Further, according to a seventh aspect of the present invention, there is provided a computer program for reproducing information stored on an information recording medium, the computer program characterized by including: a demodulating step of demodulating data read from the information recording medium; and an additional data decoding step of determining data characteristics of an additional data-corresponding recording frame and specific user control data read from the information recording medium, and obtaining additional data constituent bit information on a basis of the two determined data characteristics.

The computer programs according to the present invention can for example be provided to a computer system capable of executing various program codes by a storage medium provided in a computer readable form, or a communicating medium, for example a recording medium such as a CD, an FD, an MO or the like, or a communicating medium such as a network or the like. By providing such a program in a computer readable form, a process in accordance with the program is realized on the computer system.

Other and further objects, features, and advantages of the present invention will become apparent from more detailed description on the basis of accompanying drawings and embodiments of the present invention to be described later. It is to be noted that a system in the present specification is a logical set configuration of a plurality of devices, and that each constituent device is not necessarily within an identical casing.

According to a constitution of the present invention, when additional data is recorded onto an information recording medium, or additional information such for example as key information applied to a content decrypting process, key generating information, content reproduction control information, or copy control information is recorded onto the information recording medium, constituent bits of a data-changeable data unit, for example user control data (UCD) are controlled and set according to constituent bit information [0] or [1] of the additional data and a data characteristic of a specific additional data-corresponding recording frame selected. At a time of reproduction, the additional constituent bit information [0] or [1] can be obtained by detecting the data characteristic of the additional data-corresponding recording frame and a data characteristic of the constituent data of the user control data (UCD). With this constitution, additional information such for example as key information applied to a content decrypting process, key generating information, content reproduction control information, or copy control information is embedded in a mode difficult to analyze, and reliably read at a time of reproduction.

In addition, according to a constitution of the present invention, in a process of recording additional data, the parity of a data-changeable data unit, for example user control data (UCD) is set to even parity or odd parity by controlling constituent bits of the user control data according to constituent bit information [0] or [1] of the additional data and according to whether the parity of a specific additional data-corresponding recording frame selected is even parity or odd parity. At a time of reproduction, the additional constituent bit information [0] or [1] can be obtained by detecting the parity of the additional data-corresponding recording frame and the parity of the constituent data of the user control data (UCD). With this constitution, additional information such for example as key information applied to a content decrypting process, key generating information, content reproduction control information, or copy control information is embedded in a mode difficult to analyze, and reliably read at a time of reproduction.

### BRIEF DESCRIPTION OF DRAWINGS

FIG. 1 is a diagram showing a configuration of an information recording processing device according to the present invention;

FIGS. 2A, 2B, 2C, and 2D are diagrams (1) of assistance in explaining details of processing of a modulated data generating unit in the information recording processing device according to the present invention;

FIGS. 3D, 3E, 3F, 3G, and 3H are diagrams (2) of assistance in explaining details of processing of the modulated data generating unit in the information recording processing device according to the present invention;

FIG. 4 is a diagram of assistance in explaining a data composition of a conversion table applied in a modulation process of the information recording processing device according to the present invention;

(a) to (c) of FIG. 5 are diagrams of assistance in explaining details of processing performed in a recording signal processing circuit in the information recording processing device according to the present invention;

FIGS. 6A and 6B are diagrams of assistance in explaining details of structure of a BIS block and a BIS cluster;

FIG. 7 is a diagram of assistance in explaining user control data for setting additional data;

FIG. 8 is a diagram of assistance in explaining additional data-corresponding user control data and an additional data-corresponding recording frame;

(a) and (b) of FIG. 9 are diagrams of assistance in explaining an example of a data setting process based on additional data which process is performed in the present invention;

(a) and (b) of FIG. 10 are diagrams of assistance in explaining an example of a data setting process based on additional data which process is performed in the present invention;

(a) and (b) of FIG. 11 are diagrams of assistance in explaining an example of a data setting process based on additional data which process is performed in the present invention;

(a) and (b) of FIG. 12 are diagrams of assistance in explaining an example of a data setting process based on additional data which process is performed in the present invention;

FIG. 13 is a diagram of assistance in explaining the rule of the data setting processes based on additional data which processes are performed in the present invention;

FIG. 14 is a flowchart of assistance in explaining a additional data recording process sequence performed in the information recording processing device according to the present invention;

FIG. 15 is a diagram showing a configuration of an information reproduction processing device according to the present invention; and

FIG. 16 is a flowchart of assistance in explaining an additional data reading and data reproduction process sequence performed in the information reproduction processing device according to the present invention.

### BEST MODE FOR CARRYING OUT THE INVENTION

An information recording processing device, an information reproduction processing device, an information recording medium, and a method, and a computer program according to the present invention will hereinafter be described in detail with reference to the drawings.

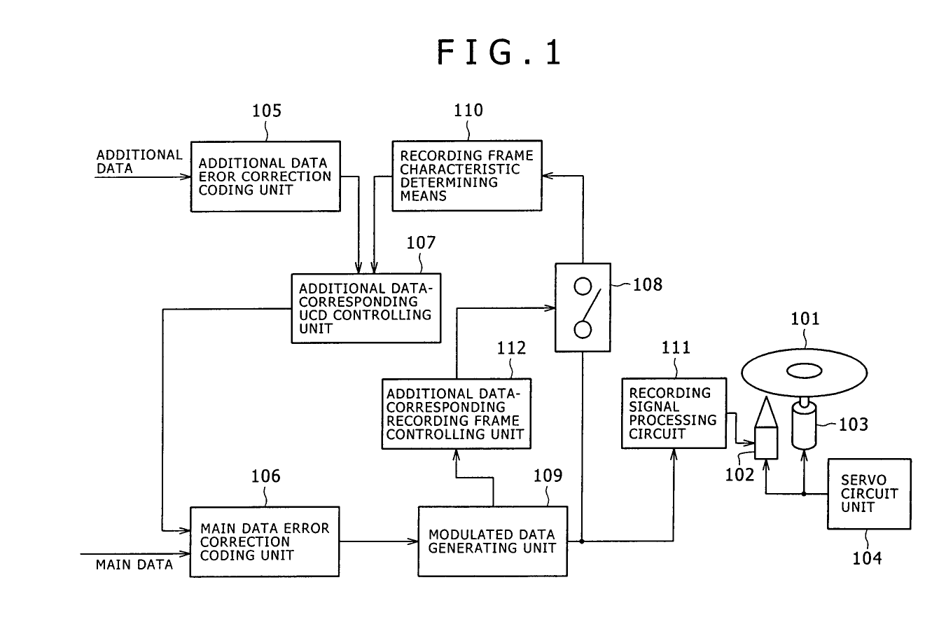

The configuration and processing of the information recording processing device according to the present invention will first be described with reference to FIG. 1. It is to be noted that the information recording processing device to be described in the following includes a mastering device as a device for manufacturing an original disk referred to as a so-called master disk, and further includes a DVD recording and reproducing device and a device having an information recording medium drive, such as a PC or the like, which devices are usable by a general user. That is, the information recording processing device includes information processing devices that can write data not only to master disks but also to various recordable or rewritable information recording media.

The configuration and processing of the information recording processing device will be described with reference to FIG. 1. The information recording processing device includes: an information recording medium 101 on which data can be recorded; a pickup 102 for outputting a data recording signal to the information recording medium 101; a spindle motor 103 for driving the information recording medium 101; a servo circuit 104 for controlling the pickup 102 and the spindle motor 103; an additional data error correction coding unit 105; a main data error correction coding unit 106; an additional data-corresponding user control data (UCD) controlling unit 107; a switch 108; a modulated data generating unit 109; recording frame characteristic determining means 110; and a recording signal processing circuit 111.

Content data to be recorded on the information recording medium 101 is encrypted content data, for example. The content data is input as main data to the main data error correction coding unit 106. The main data error correction coding unit 106 performs a coding process of generating an error correcting code and adding the error correcting code to the input data.

Thereafter the modulated data generating unit 109 performs a modulating process. The information recording processing device according to the present invention performs modulation based on an RLL (1, 7) modulation system for basically modulating two-bit data into three-bit data.

The modulation based on the RLL (1, 7) modulation system is a data conversion system for providing modulated data in accordance with an RLL (1, 7) run length limitation in which data the number of consecutive [0] bits after the modulation is in a range of a minimum of one to a maximum of seven. Incidentally, a conversion table is used in this conversion process. A concrete example of use of a conversion table will be described later.

A recording unit referred to as a recording frame in which a synchronizing signal is set is generated on the basis of the modulated data, and recorded onto the information recording medium 101 via the recording signal processing circuit 111.

The modulating process is performed after a DC control bit [0] or [1] is selected and inserted at certain intervals of the input main data so as to reduce an absolute value of DSV (Digital Sum Variation) at the time of modulation.

The digital sum variation (DSV) is an index of a DC balance of an NRZI converted signal generated as a recording signal to be recorded on the information recording medium. Specifically, with the DSV as a value obtained by accumulating bits [0] in a recording bit sequence (NRZI converted signal) as [−1] and bits [1] in the recording bit sequence (NRZI converted signal) as [+1], the modulating process is performed after a DC control bit [0] or [1] is selected and inserted so as to reduce a deviation of the DSV from zero. Incidentally, an NRZI conversion process will be described later in detail.

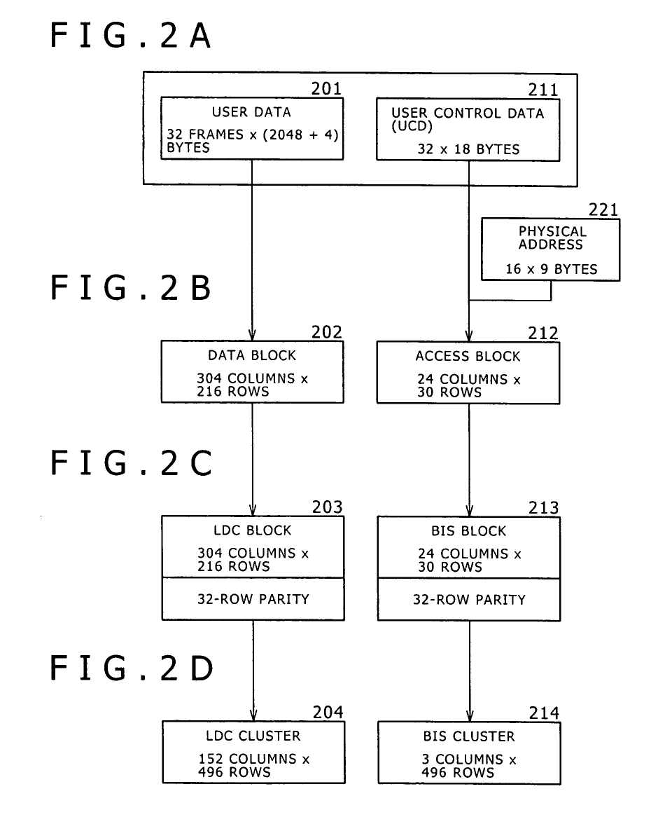

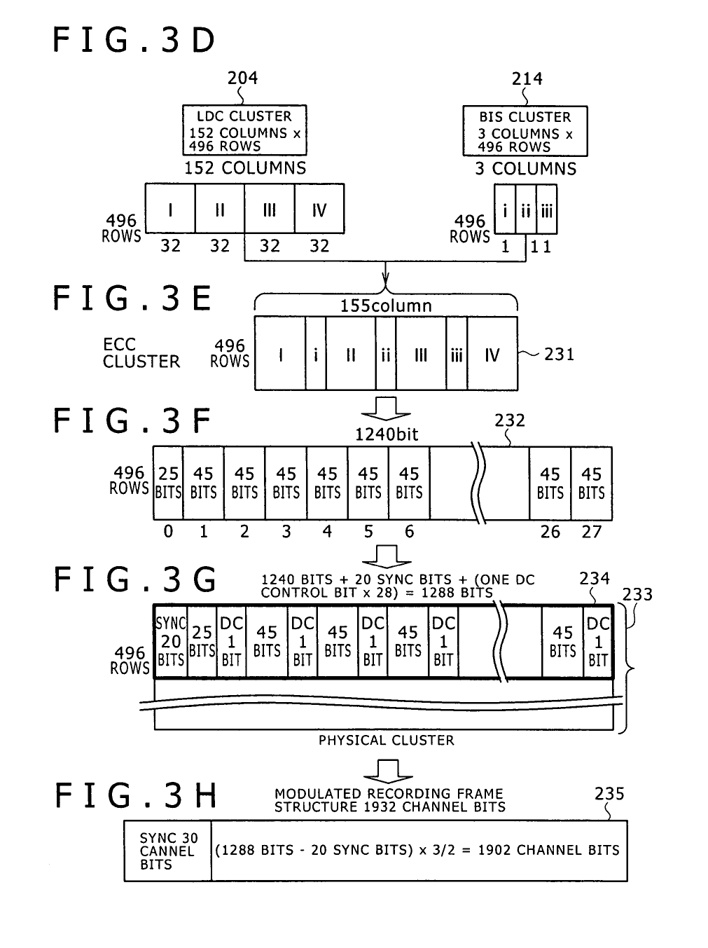

A modulated data generating process performed in the modulated data generating unit 109 will be described in detail with reference to FIG. 2 and FIG. 3.

As shown in FIG. 2A, recording data is formed by user data 201 and user control data (UCD) 211. The user data 201 includes entity data of data to be reproduced such as contents or the like. The user control data (UCD) 211 includes various control data such as reproduction control information and the like.

The user data 201 is set as a unit of 32 frames of 2048-byte data and four-byte parity. The user control data (UCD) 211 is formed by 32 units of 18-byte data.

A data block 202 is formed on the basis of the user data 201 of 32 frames×(2048+4) bytes. The data block 202 has an arrangement of 304 columns×216 rows. Incidentally, one column×one row stores one-byte (eight-bit) data.

An LDC block 203 is generated as a data block obtained by adding 32-row parity to each column of the data block 202. An LDC cluster 204 of 152 columns×496 rows is generated by subjecting the LDC block 203 to an interleaving process.

The user control data (UCD) 211 is combined with physical address data 221 of 16×9 bytes, whereby an access block 212 of 24 columns×30 rows is generated. A BIS block 213 is generated as a data block obtained by adding 32-row parity to each column of the access block 212. A BIS cluster 214 of three columns×496 rows is generated by subjecting the BIS block 213 to an interleaving process.

FIG. 3D shows the same data as in FIG. 2D, that is, the LDC cluster 204 of 152 columns×496 rows generated on the basis of the user data 201 and the BIS cluster 214 of three columns×496 rows generated on the basis of the user control data (UCD) 211.

As shown in FIG. 3D, the LDC cluster 204 of 152 columns×496 rows is divided into four parts (I to IV) as units of 32 columns, and the BIS cluster 214 of three columns×496 rows is divided into three parts (i to iii) as units of one column. These parts are alternately combined with each other, whereby an ECC cluster 231 of 155 columns×496 rows shown in FIG. 3E is generated.

Further, the ECC cluster 231 is set as a cluster 232 divided into 28 parts 0 to 27 as shown in FIG. 3F. Only the part 0 is 25 bits, and the other parts 1 to 27 are 45 bits. Incidentally, the number of bits shown in FIG. 3F is the number of bits per row.

Further, as shown in FIG. 3G, 20 synchronizing (Sync) bits are set. In addition, one DC control bit is set between the parts 0 to 27 of FIG. 3F.

As a result, a physical cluster 233 of [1240+20 (Sync)+(one DC control×28)=1288]×496 rows is set. Each row of the physical cluster 233 is a recording frame 234 as a modulated data generating process unit.

Incidentally, the DC control bits are an index of a DC balance of an NRZI converted signal generated as a recording signal to be recorded on the information recording medium. Specifically, with DSV as a value obtained by accumulating bits [0] in a recording bit sequence (NRZI converted signal) as [−1] and bits [1] in the recording bit sequence (NRZI converted signal) as [+1], a DC control bit [0] or [1] is selected and inserted so as to reduce a deviation of the DSV from zero.

Next, the recording frame 234 formed by 1288-bit data is subjected to a modulation process for converting two-bit data into three-bit data. In this data conversion, RLL (1, 7) data conversion is performed to provide modulated data in accordance with an RLL (1, 7) run length limitation in which data the number of consecutive [0] bits is in a range of a minimum of one to a maximum of seven, whereby a modulated recording frame 235 is generated.

The modulated recording frame 235 is formed by a total of 1932 channel bits as modulated data bits, that is, 30 synchronizing (Sync) channel bits and (1288×20 sync bits)×2/3=1902 channel bits.

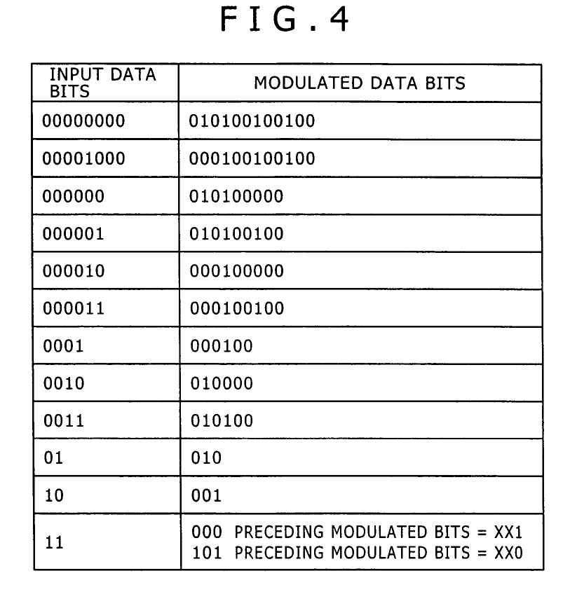

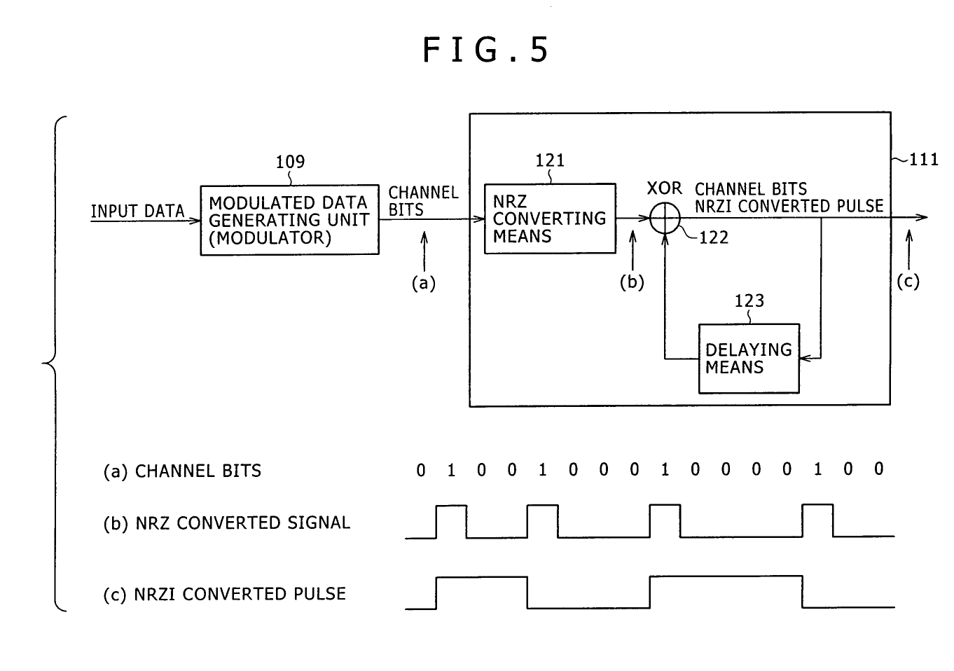

A conversion table is used in the process of data modulation from two bits to three bits in accordance with an RLL (1, 7) run length rule. A concrete example of a conversion table is shown in FIG. 4.

As shown in FIG. 4, the conversion table is constructed as a table associating modulated data bits with input bits. When input data is [00000000], for example, modulated data bits are [010100100100]. In a case of input data of [11], modulated data bits are [000] when preceding modulated data bits are [xx1], and modulated data bits are [101] when preceding modulated data bits are [xx0].

Modulated data bits in accordance with the RLL (1, 7) run length rule are generated by performing data conversion from two bits to three bits according to this table.

Returning to FIG. 1, description of the configuration and processing of the information recording processing device according to the present invention will be continued. The modulated data generating process described with reference to FIGS. 2A to 4 is performed in the modulated data generating unit 109 in FIG. 1, and a recording signal based on the generated modulated data is generated in the recording signal processing circuit 111.

The recording signal processing circuit 111 generates an NRZI (Non Return to Zero Inverted) signal whose pulse polarity is inverted according to a value [0] or [1] of the modulated data generated by the modulated data generating unit 109. This signal is recorded as a recording signal onto the information recording medium 101.

FIG. 5 shows a configuration for a process of generating an NRZI as a recording signal which process is performed in the recording signal processing circuit 111. Channel bits as modulated data bits output from the modulated data generating unit 109 is input to the recording signal processing circuit 111 including NRZ converting means 121, exclusive OR means (XOR) 122, and delaying means 123. (a) of FIG. 5 shows channel bits; (b) of FIG. 5 shows an output signal from the NRZ converting means 121; and (c) of FIG. 5 shows NRZI converted pulses, which are a recording signal as a final output of the recording signal processing circuit 111. This recording signal is output to the pickup 102, so that the recording information is recorded onto the information recording medium 101 under control of the servo circuit 104.

The constitution of the present invention enables additional data to be recorded and read in a manner difficult to analyze, by a combination of a characteristic of controllable data such as user control information (UCD) or the like that does not affect actual data such as contents or the like and a characteristic of specific recording data (recording frame).

For example, the constitution represents a constituent bit [0] or [1] of additional data by controlling a combination of a recording frame characteristic (1) and a user control data (UCD) characteristic described as follows.

(1) A characteristic of a specific recording frame selected as a recording frame corresponding to the additional data, specifically a characteristic of even parity or odd parity, for example.

(2) A characteristic of user control data (UCD) having adjustable data bits which data is selected as UCD corresponding to the additional data, specifically a characteristic of even parity or odd parity, for example.

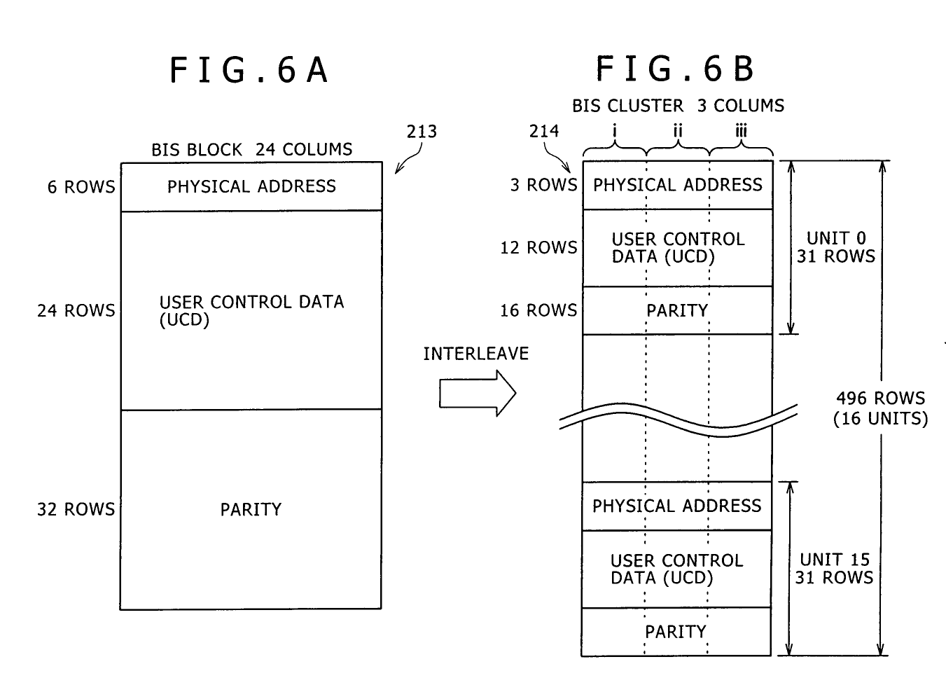

Details of this additional bit setting process constitution will be described below. FIGS. 6A and 6B are diagrams showing details of a BIS block 213 and a BIS cluster 214 generated on the basis of user control data 211 in the modulated data generating process described with reference to FIGS. 2A to 3H.

As described with reference to FIGS. 2A to 3H, the user control data (UCD) 211 is combined with physical address data 221 of 16×9 bytes, whereby an access block 212 of 24 columns×30 rows is generated. A BIS block 213 is then generated as a data block obtained by adding 32-row parity to each column of the access block 212. The BIS block 213 is shown in FIG. 6A.

A BIS cluster 214 of three columns×496 rows is generated by subjecting the BIS block 213 to an interleaving process. The BIS cluster is shown in FIG. 6B.

In the BIS cluster, as shown in FIG. 6B, one unit of three columns×31 rows is set by a three-row physical address, 12-row user control data (UCD), and 16-row parity. The BIS cluster 214 of three columns×496 rows is formed by 16 units 0 to 15.

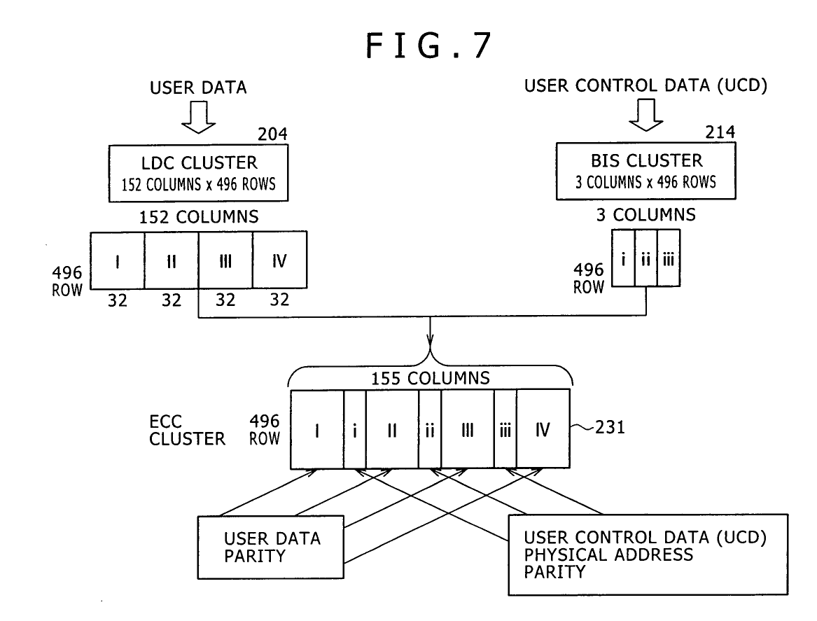

As shown in FIG. 7, as described above with reference to FIGS. 2A to 3H, each column of the BIS cluster having this composition is inserted between four divided pieces of data I to IV of a LDC cluster 204 set on the basis of user data such as contents or the like, whereby an ECC cluster 231 is generated.

As shown in FIG. 7, the ECC cluster is set as a cluster formed by combining the LDC cluster of 152 columns×496 rows with the BIS cluster 214 of three columns×496 rows.

As described with reference to FIG. 6B, one of a physical address, user control data (UCD), and parity is set in each row of the BIS cluster. Hence, the BIS cluster (i, ii, and iii) included in each row of the 496 rows of the ECC cluster 231 is one of a physical address, user control data (UCD), and parity.

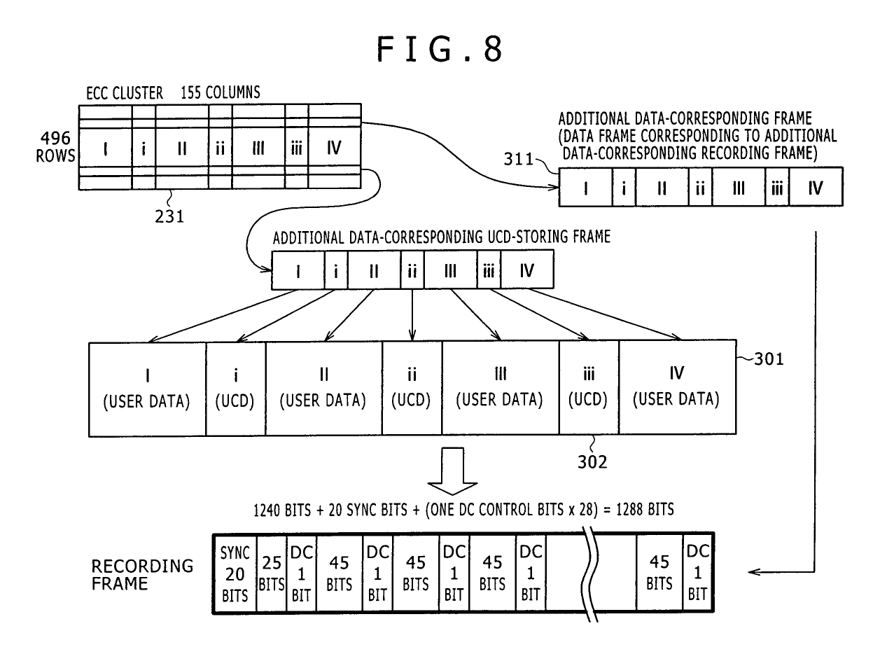

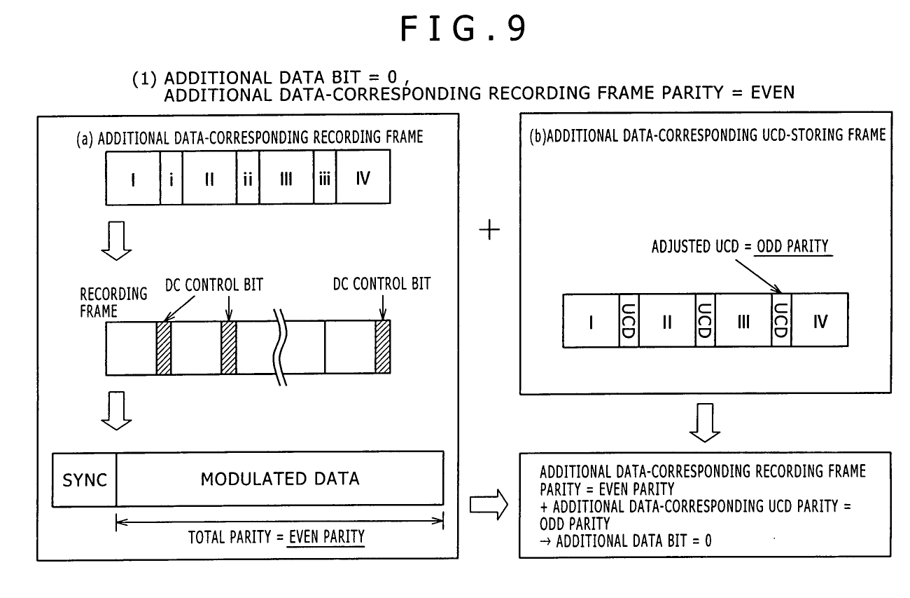

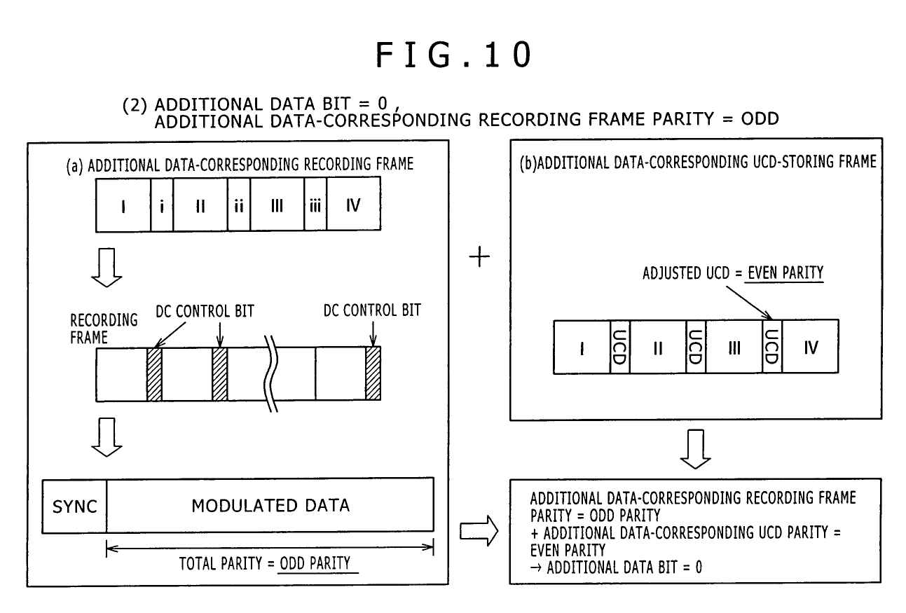

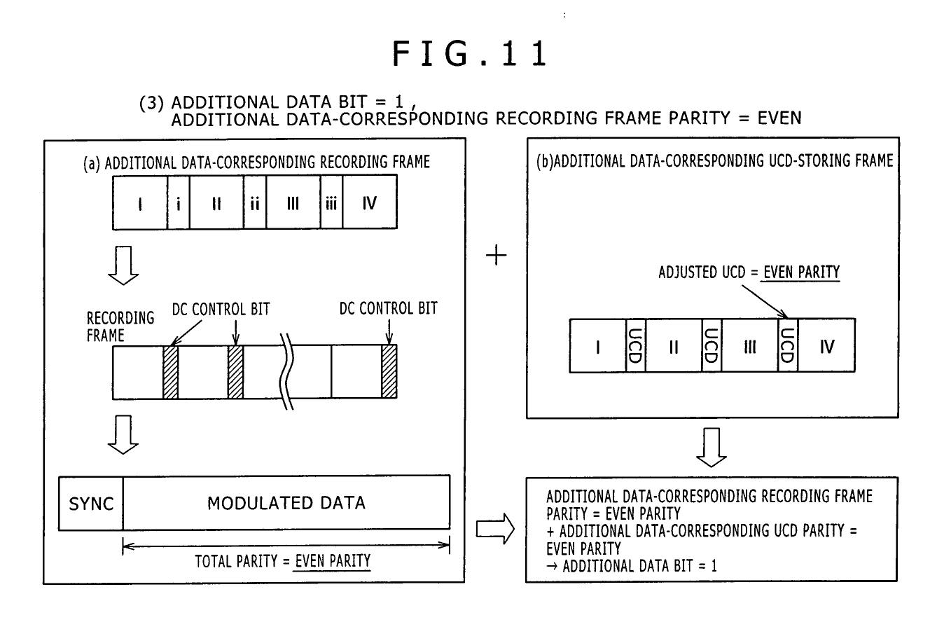

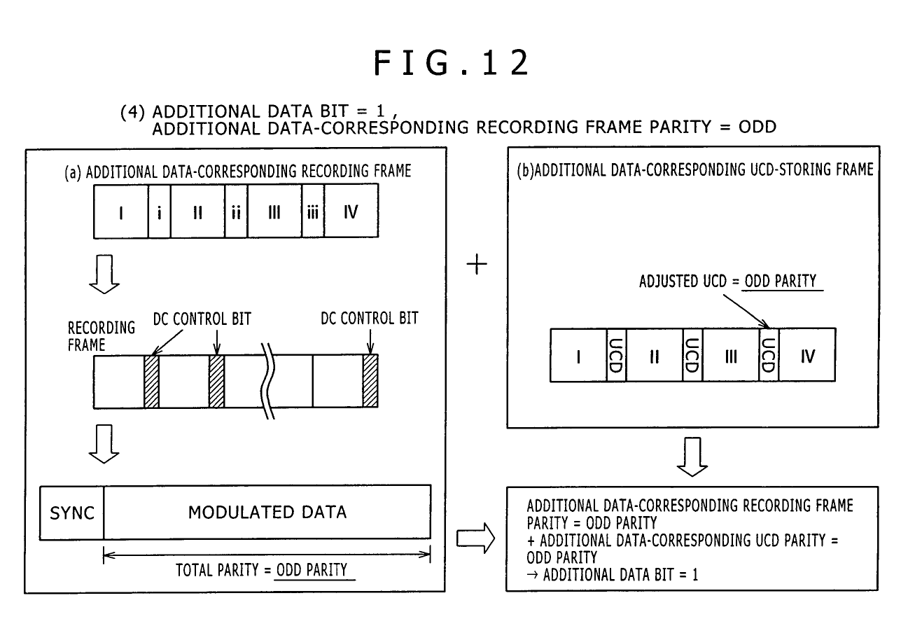

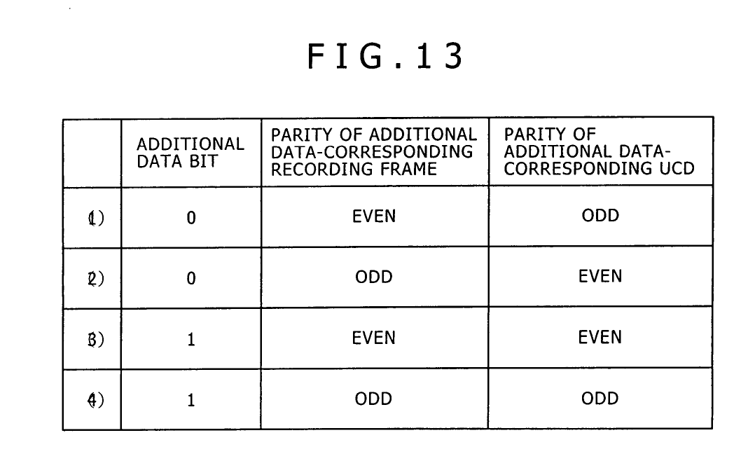

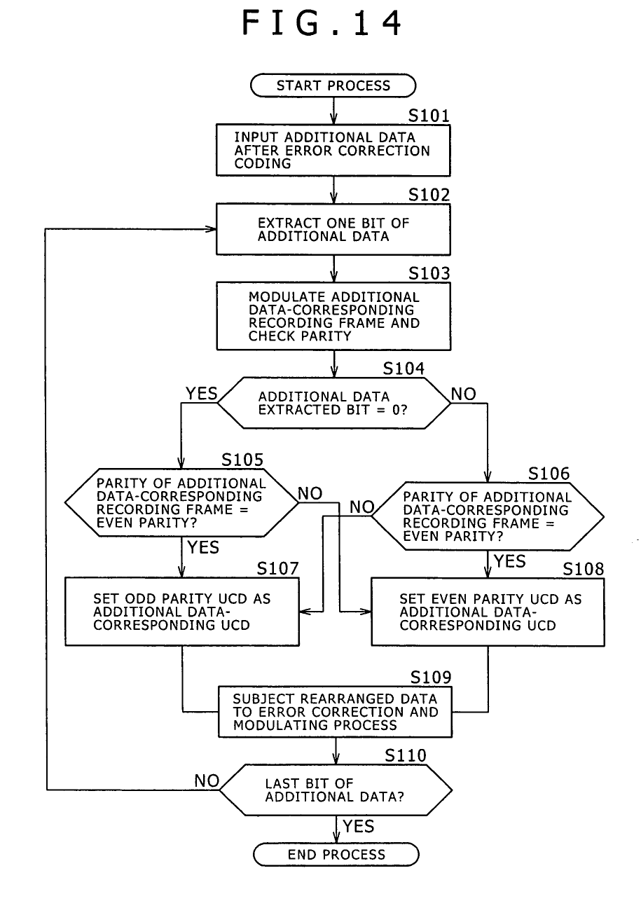

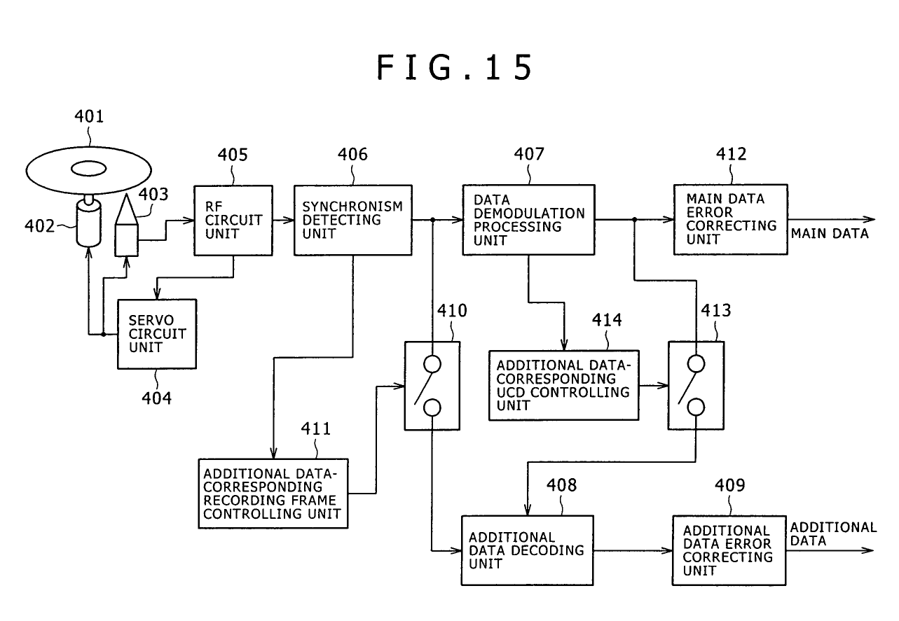

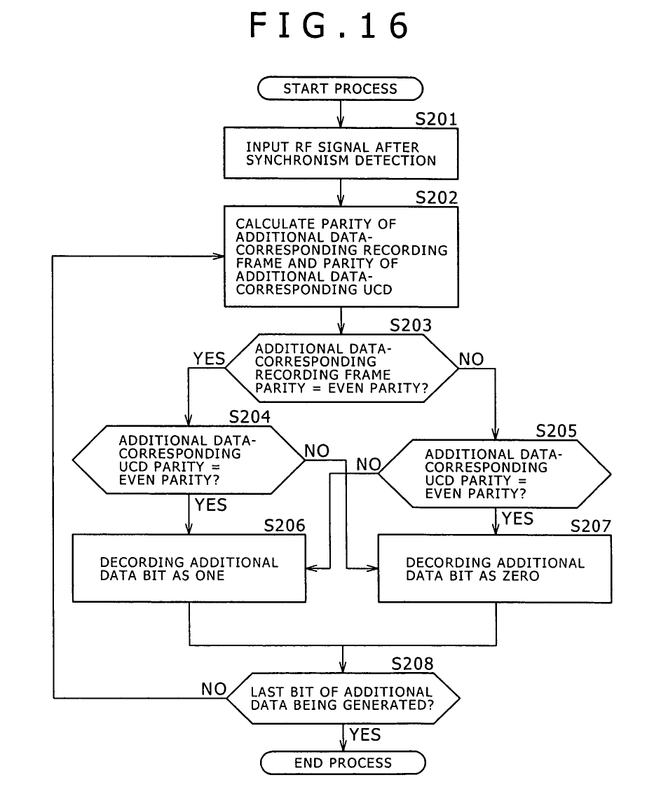

As shown in FIG. 8, a specific row of the 496 rows of the ECC cluster 231 is set such that user control data (UCD) is inserted between pieces of user data I to IV such as contents or the like, as shown in a data frame 301.

While the user control data (UCD) is set as an area in which to store various information such as content reproduction control information and the like, a part of the user control data (UCD) is set as a reserve area or the like in which area arbitrary data can be written.

In the present invention, a value stored in the user control data (UCD) where arbitrary data can be written is controlled according to the value [0] or [1] of an additional data bit and another specific recording frame (a characteristic (for example parity) of modulated data of an additional data-corresponding recording frame generated on the basis of an additional data-corresponding frame 311 shown in FIG. 8). The data characteristic of the UCD-stored value is thus controlled and set.

The control of the characteristic of the user control data (UCD) is specifically control that makes the parity of the UCD even parity or odd parity. For example, the parity is adjusted by setting user control data (UCD) 302 shown in FIG. 8 as additional data-corresponding user control data (UCD) and controlling the bit value of constituent bits (eight bits) of the additional data-corresponding user control data (UCD) 302. That is, the parity of the additional data-corresponding user control data (UCD) 302 is controlled to be even parity or odd parity.

Incidentally, even parity in a data area corresponds to a cumulative value of the number of bits 1 included in the data area being an even number. Odd parity in a data area corresponds to a cumulative value of the number of is included in the data area being an odd number.

When the parity of the additional data-corresponding user control data (UCD) 302 is set to even parity, the number of is included in the eight bits of the additional data-corresponding user control data (UCD) 302 is set to an even number. When the parity of the additional data-corresponding user control data (UCD) 302 is set to odd parity, the number of is included in the eight bits of the additional data-corresponding user control data (UCD) 302 is set to an odd number.

The data frame 301 having the thus controlled additional data-corresponding user control data (UCD) 302 is converted into a recording frame by inserting DC control bits into the data frame 301, as shown in FIG. 8. The recording frame is then converted into a modulated recording frame (see FIG. 3H) by performing the modulating process of making conversion from two bits to three bits according to the RLL (1, 7) run length rule and further adding a synchronizing (Sync) code to the recording frame. Thereafter an NRZI signal generated on the basis of the modulated recording frame in the recording signal processing circuit 111 (see FIG. 1) is recorded onto the information recording medium 101.

As shown in FIG. 8, the additional data-corresponding frame 311 is set in addition to the data frame 301 having the additional data-corresponding user control data (UCD) 302. The additional data-corresponding recording frame generated on the basis of the additional data-corresponding frame 311 is also converted into a recording frame by inserting DC control bits into the frame, as shown in FIG. 8. The recording frame is then converted into a modulated recording frame (see FIG. 3H) by performing the modulating process of making conversion from two bits to three bits according to the RLL (1, 7) run length rule and further adding a synchronizing (Sync) code to the recording frame. Thereafter an NRZI signal generated on the basis of the modulated recording frame in the recording signal processing circuit 111 (see FIG. 1) is recorded onto the information recording medium 101.

Incidentally, the additional data-corresponding recording frame may be a data frame including user control information (UCD) in the BIS cluster of FIG. 6B, another data frame including a physical address, or a data frame including parity; an arbitrary data frame can be set as the additional data-corresponding recording frame.

The constitution of the present invention sets and reads a constituent bit of additional data on the basis of the two data frames, that is, the additional data-corresponding UCD storing frame and the additional data-corresponding recording frame.

Returning to FIG. 1, description will be made of the processing of the information recording processing device according to the present invention. Additional data is input to the additional data error correction coding unit 105 to be subjected to a coding process of adding an error correcting code. Incidentally, the additional data is formed by various information such as encryption key information, encryption key generating information, content reproduction control information, content copy control information, and other content attribute information.

The additional data-corresponding UCD (user control data) controlling unit 107 is supplied with a bit string of the additional data to which the error correcting code is added. The bit string is a data string of [0, 0, 0, 1, 0, 0, 0 . . . ], for example. This bit string includes for example the additional data of either encryption key information, encryption key generating information, content reproduction control information, content copy control information, or other content attribute information, and the error correcting code for the additional data.

The additional data-corresponding UCD (user control data) controlling unit 107 is supplied with the bit string of the additional data, and supplied with a data characteristic (for example parity) of modulated data of a specific recording frame, that is, an additional data-corresponding recording frame from the recording frame characteristic determining means 110.

The additional data-corresponding UCD controlling unit 107 performs control according to the value [0] or [1] of an additional data bit and the data characteristic (for example the parity) of the additional data-corresponding recording frame. That is, the additional data-corresponding UCD controlling unit 107 controls and sets the data characteristic of a UCD-stored value. The additional data-corresponding user control data (UCD) controlling unit 107 inputs the set UCD data to the main data error correction coding unit. After error correction, a modulated recording frame (see FIG. 3H) generated by performing the modulating process according to FIGS. 2A to 3H in the modulated data generating unit 109 is input to the recording signal processing circuit 111. An NRZI signal generated on the basis of the modulated recording frame is recorded onto the information recording medium 101.

The additional data-corresponding recording frame controlling unit 107 turns on the switch 108 in timing in which the additional data-corresponding recording frame is output from the modulated data generating unit 109 on the basis of information input from the modulated data generating unit 109. The additional data-corresponding recording frame controlling unit 112 thereby allows the additional data-corresponding recording frame to be output to the recording frame characteristic determining means 110. Incidentally, the additional data-corresponding recording frame is also output to the recording signal processing circuit 111 so that a normal writing process is performed.

The recording frame characteristic determining means 110 determines the data characteristic of the additional data-corresponding recording frame, or specifically determines whether the parity of constituent data of the modulated data of the additional data-corresponding recording frame is even parity or odd parity. The recording frame characteristic determining means 110 outputs a result of the determination to the additional data-corresponding controlling unit 107.

The additional data-corresponding controlling unit 107 controls the data characteristic (for example parity) of an additional data-corresponding UCD-stored value, and sets constituent bits of the UCD on the basis of the value [0] or [1] of the additional data bit input from the additional data error correction coding unit 105 and the data characteristic (for example parity) of the additional data-corresponding recording frame which characteristic is input from the recording frame characteristic determining means 110. The set UCD data is input to the main data error correction coding unit.

Details of an additional data storing process in the present invention will be described with reference to

(a) and (b) of FIG. 9, (a) and (b) of FIG. 10, (a) and (b) of FIG. 11, and (a) and (b) of FIG. 12.

(a) and (b) of FIG. 9 are diagrams representing a process of setting additional data-corresponding UCD when a constituent bit of additional data is [0] and the parity of a modulated data area corresponding to a specific recording frame (additional data-corresponding recording frame) is even parity.

Incidentally, RLL (1, 7) modulation has a parity preserving characteristic, that is, has a characteristic in that modulated data of even parity data has even parity, and modulated data of odd parity data has odd parity. Hence, the parity of the modulated data and the parity of the recording frame shown in (a) of FIG. 9 are the same, and thus either may be applied.

It is to be noted that while an example in which parity is used as a data characteristic of the additional data-corresponding recording frame and additional data-corresponding UCD is shown in the following, the data characteristic is not limited to parity, and various other detectable data characteristics are applicable.

In the case of (a) and (b) of FIG. 9, that is, when a constituent bit of additional data is [0] and the parity of a specific recording frame (additional data-corresponding recording frame) is even parity as shown in (a) of FIG. 9, additional data-corresponding UCD is set to odd parity by a bit configuration, as shown in (b) of FIG. 9. Specifically, the parity of the additional data-corresponding user control data (UCD) is set to odd parity by setting the number of is included in the eight bits of the additional data-corresponding user control data (UCD) to an odd number.

As a result, two conditions are set in which the parity of the specific recording frame (additional data-corresponding recording frame) is even parity, and the parity of the additional data-corresponding user control data (UCD) is odd parity.

A reproducing device performing data reproduction detects two data characteristics (parity) of the additional data-corresponding recording frame and the additional data-corresponding user control data (UCD). When the reproducing device detects the above conditions as a result of the detection, that is, detects that the parity of the additional data-corresponding recording frame is even parity, and that the parity of the additional data-corresponding user control data (UCD) is odd parity, the reproducing device determines that the bit value of the additional data is [0]. Incidentally, an additional data detecting process of the reproducing device will be described later in detail.

(a) and (b) of FIG. 10 are diagrams representing a process of setting additional data-corresponding UCD when a constituent bit of additional data is [0] and the parity of a modulated data area corresponding to a specific recording frame (additional data-corresponding recording frame) is odd parity (see (a) of FIG. 10).

In the case of the settings of (a) and (b) of FIG. 10, additional data-corresponding UCD is set to even parity by a bit configuration, as shown in (b) of FIG. 10. Specifically, the parity of the additional data-corresponding user control data (UCD) is set to even parity by setting the number of 1s included in the eight bits of the additional data-corresponding user control data (UCD) to an even number.

As a result, two conditions are set in which the parity of the specific recording frame (additional data-corresponding recording frame) is odd parity, and the parity of the additional data-corresponding user control data (UCD) is even parity.

A reproducing device performing data reproduction detects two data characteristics (parity) of the additional data-corresponding recording frame and the additional data-corresponding user control data (UCD). When the reproducing device detects the above conditions as a result of the detection, that is, detects that the parity of the additional data-corresponding recording frame is odd parity, and that the parity of the additional data-corresponding user control data (UCD) is even parity, the reproducing device determines that the bit value of the additional data is [0].

(a) and (b) of FIG. 11 are diagrams representing a process of setting additional data-corresponding UCD when a constituent bit of additional data is [1] and the parity of a modulated data area corresponding to a specific recording frame (additional data-corresponding recording frame) is even parity (see (a) of FIG. 11).

In the case of the settings of (a) and (b) of FIG. 11, additional data-corresponding UCD is set to even parity by a bit configuration, as shown in (b) of FIG. 11. Specifically, the parity of the additional data-corresponding user control data (UCD) is set to even parity by setting the number of is included in the eight bits of the additional data-corresponding user control data (UCD) to an even number.

As a result, two conditions are set in which the parity of the specific recording frame (additional data-corresponding recording frame) is even parity, and the parity of the additional data-corresponding user control data (UCD) is even parity.

A reproducing device performing data reproduction detects two data characteristics (parity) of the additional data-corresponding recording frame and the additional data-corresponding user control data (UCD). When the reproducing device detects the above conditions as a result of the detection, that is, detects that the parity of the additional data-corresponding recording frame is even parity, and that the parity of the additional data-corresponding user control data (UCD) is even parity, the reproducing device determines that the bit value of the additional data is [1].

(a) and (b) of FIG. 12 are diagrams representing a process of setting additional data-corresponding UCD when a constituent bit of additional data is [1] and the parity of a modulated data area corresponding to a specific recording frame (additional data-corresponding recording frame) is odd parity (see (a) of FIG. 12).

In the case of the settings of (a) and (b) of FIG. 12, additional data-corresponding UCD is set to odd parity by a bit configuration, as shown in (b) of FIG. 12. Specifically, the parity of the additional data-corresponding user control data (UCD) is set to odd parity by setting the number of 1s included in the eight bits of the additional data-corresponding user control data (UCD) to an odd number.

As a result, two conditions are set in which the parity of the specific recording frame (additional data-corresponding recording frame) is odd parity, and the parity of the additional data-corresponding user control data (UCD) is odd parity.

A reproducing device performing data reproduction detects two data characteristics (parity) of the additional data-corresponding recording frame and the additional data-corresponding user control data (UCD). When the reproducing device detects the above conditions as a result of the detection, that is, detects that the parity of the additional data-corresponding recording frame is odd parity, and that the parity of the additional data-corresponding user control data (UCD) is odd parity, the reproducing device determines that the bit value of the additional data is [1].

FIG. 13 is a table summarizing an additional data embedding rule, that is, correspondences between a bit of additional data, the parity of an additional data-corresponding recording frame, and the parity of additional data-corresponding user control data (UCD).

FIG. 13 shows four patterns (1) to (4) described with reference to (a) of FIG. 9 to (b) of FIG. 12.

The pattern (1) represents a case where the constituent bit of the additional data is [0] and the parity of the additional data-corresponding recording frame is even parity. In this case, the parity of the additional data-corresponding user control data (UCD) is set as odd parity.

The pattern (2) represents a case where the constituent bit of the additional data is [0] and the parity of the additional data-corresponding recording frame is odd parity. In this case, the parity of the additional data-corresponding user control data (UCD) is set as even parity.

The pattern (3) represents a case where the constituent bit of the additional data is [1] and the parity of the additional data-corresponding recording frame is even parity. In this case, the parity of the additional data-corresponding user control data (UCD) is set as even parity.

The pattern (4) represents a case where the constituent bit of the additional data is [1] and the parity of the additional data-corresponding recording frame is odd parity. In this case, the parity of the additional data-corresponding user control data (UCD) is set as odd parity.

A reproducing device at a time of reproduction detects the two parities of the additional data-corresponding recording frame and the additional data-corresponding user control data (UCD). The reproducing device determines whether the constituent bit of the additional data is [0] or [1] by determining which of the patterns (1) to (4) corresponds to the two parities.

The sequence of an additional data recording process performed in the information recording processing device according to the present invention will next be described with reference to FIG. 14.

In step S101, additional data after error correction coding is input. This data is obtained as output data from the additional data error correction coding unit 105 shown in FIG. 1. Incidentally, the additional data is formed by various information such as encryption key information, encryption key generating information, content reproduction control information, content copy control information, and other content attribute information. A bit string of the additional data which string is obtained by adding an error correcting code to the additional data, for example a bit string [0, 0, 0, 1, 0, 0, 0 . . . ] or the like is input.

In step S102, one bit is extracted as a recording bit in order from constituent bits, for example, [0, 0, 0, 1, 0, 0, 0 . . . ] of the additional data. In step S103, a specific recording frame, that is, an additional data-corresponding recording frame is modulated, and the data characteristic (parity) of the modulated data is determined.

The modulated data generating unit 109 shown in FIG. 1 modulates the additional data-corresponding recording frame. The output of the modulated data generating unit 109 is input to the recording frame characteristic determining means 110 via the switch 108. The recording frame characteristic determining means 110 modulates the additional data-corresponding recording frame, and detects the data characteristic (parity) of the modulated data.

Incidentally, as described above, RLL (1, 7) modulation has a parity preserving characteristic, that is, has a characteristic in that modulated data of even parity data has even parity, and modulated data of odd parity data has odd parity. Hence, while in FIG. 1, the modulated data generating unit 109 modulates the additional data-corresponding recording frame, the output of the modulated data generating unit 109 is input to the recording frame characteristic determining means 110 via the switch 108, and the data characteristic (parity) of the modulated data is detected, the parity of the modulated data and the parity of the recording frame are the same, and thus either may be set to be detected.

In step S104, it is determined whether the extracted bit of the additional data, that is, the bit extracted in order from the bit string of the additional data which string is obtained by adding an error correcting code to the additional data, for example the bit string [0, 0, 0, 1, 0, 0, 0 . . . ] is [0].

When the extracted bit is [0], the process proceeds to step S105. When the extracted bit is [1], the process proceeds to step S106.

When the extracted bit is [0], it is determined in step S105 whether the parity of the specific recording frame which parity is determined in step S103 is even parity.

When the parity of the specific recording frame is even parity, the process proceeds to step S107, where the parity of additional data-corresponding UCD (user control information) is set to odd parity. Specifically, the parity of the additional data-corresponding user control data (UCD) is set to odd parity by setting the number of is included in the eight bits of the additional data-corresponding user control data (UCD) to an odd number. This process corresponds to a process for (1) in FIG. 13.

When it is determined in step S105 that the parity of the specific recording frame is odd parity, the process proceeds to step S108, where the parity of the additional data-corresponding UCD (user control information) is set to even parity. Specifically, the parity of the additional data-corresponding user control data (UCD) is set to even parity by setting the number of is included in the eight bits of the additional data-corresponding user control data (UCD) to an even number. This process corresponds to a process for (2) in FIG. 13.

When the extracted bit is [1], it is determined in step S106 whether the parity of the specific recording frame which parity is determined in step S103 is even parity.

When the parity of the specific recording frame is even parity, the process proceeds to step S108, where the parity of the additional data-corresponding UCD (user control information) is set to even parity. Specifically, the parity of the additional data-corresponding user control data (UCD) is set to even parity by setting the number of is included in the eight bits of the additional data-corresponding user control data (UCD) to an even number. This process corresponds to a process for (3) in FIG. 13.

When it is determined in step S106 that the parity of the specific recording frame is odd parity, the process proceeds to step S107, where the parity of the additional data-corresponding UCD (user control information) is set to odd parity. Specifically, the parity of the additional data-corresponding user control data (UCD) is set to odd parity by setting the number of 1 s included in the eight bits of the additional data-corresponding user control data (UCD) to an odd number. This process corresponds to a process for (4) in FIG. 13.

In step S109, a data frame in which the user control data (UCD) controlled according to the additional data is disposed is subjected to error correction and a modulating process. The main data error correction coding unit 106 shown in FIG. 1 performs the error correction. The modulated data generating unit 109 shown in FIG. 1 subjects the data frame in which the user control data (UCD) controlled according to the additional data is disposed to the modulating process.

In step S110, it is determined whether processing of a last bit of the additional data is completed. When there is unprocessed data, the process from step S102 on down is repeated.

When it is determined in step S110 that there is no unprocessed data, the process is ended, that is, recording data having additional information bits inserted therein is generated according to the above-described process.

Description will next be made of a configuration and a reproducing process sequence of a data reproduction processing device that reproduces an information recording medium storing the above-described additional information and contents (main data) such as a movie, music or the like.

The configuration and processing of the data reproduction processing device will be described with reference to FIG. 15. The data reproduction processing device includes: an information recording medium 401; a pickup 402 for reading data from the information recording medium 401; a spindle motor 403 for driving the information recording medium 401; a servo circuit 404 for controlling the pickup 402 and the spindle motor 403; an RF circuit unit 405 for performing signal processing such as gain adjustment of a read signal and the like, and generating an RF signal; a synchronism detecting unit 406 for extracting a synchronizing signal from the RF signal; and a data demodulation processing unit 407 for performing data demodulation processing.

Further, the data reproduction processing device includes: an additional data-corresponding recording frame controlling unit 411 for detecting an additional data-corresponding recording frame, and making a switch 410 operate in response to the detection of the additional data-corresponding recording frame to output the additional data-corresponding recording frame to an additional data decoding unit 408; an additional data-corresponding UCD controlling unit 414 for detecting additional data-corresponding UCD, and making a switch 413 operate in response to the detection of the additional data-corresponding UCD to output the additional data-corresponding UCD to the additional data decoding unit 408; the additional data decoding unit 408 for decoding additional data; a main data error correcting unit 412 for performing error correction processing on main data; and an additional data error correcting unit 409 for performing error correction processing on the additional data.

Content data stored on the information recording medium 401 is encrypted content data, for example. The additional data stored on the information recording medium 401 is for example key data applied to the decryption of encrypted contents, key generating information, content reproduction control information, content copy control information, and other content attribute information.

Data read from the information recording medium 401 via the pickup 402 is subjected to signal processing such as gain adjustment and the like in the RF circuit unit 405, and then input to the synchronism detecting unit 406. The synchronism detecting unit 406 detects a synchronizing signal (sync) in the recorded signal. The synchronism detecting unit 406 outputs the detected signal to the additional data-corresponding recording frame controlling unit 411. The additional data-corresponding recording frame controlling unit 411 determines an area of an additional data-corresponding recording frame on the basis of the synchronizing signal input from the synchronism detecting unit 406. The additional data-corresponding recording frame controlling unit 411 controls the switch 410 on the basis of determination information to input modulated data of the additional data-corresponding recording frame to the additional data decoding unit 408, which decodes the additional data-corresponding recording frame.

Further, the data read from the information recording medium 401 is output from the synchronism detecting unit 406 to the data demodulating unit 407, where data conversions reverse to those described above with reference to FIGS. 2A to 3H are sequentially performed. The additional data-corresponding UCD controlling unit 414 determines an area of additional data-corresponding UCD on the basis of information input from the data demodulating unit 407. The additional data-corresponding UCD controlling unit 414 controls the switch 413 on the basis of determination information to input the additional data-corresponding UCD to the additional data decoding unit 408, which decodes the additional data-corresponding UCD.

The additional data decoding unit 408 performs a decoding process to obtain additional data on the basis of the two pieces of input data, that is, the modulated data of the additional data-corresponding recording frame and the additional data-corresponding UCD (user control data).

Specifically, two data characteristics (parities), that is, a data characteristic (parity) of the modulated data of the additional data-corresponding recording frame and a data characteristic (parity) of the additional data-corresponding UCD (user control data) are detected. Whether a constituent bit of the additional data is [0] or [1] is determined on the basis of detection information.

That is, whether the constituent bit of the additional data is [0] or [1] is determined according to the rule described above with reference to FIG. 13.

Specifically, when the parity of the additional data-corresponding recording frame is even parity, and the parity of the additional data-corresponding user control data (UCD) is odd parity, it is determined that the constituent bit of the additional data is [0].

When the parity of the additional data-corresponding recording frame is odd parity, and the parity of the additional data-corresponding user control data (UCD) is even parity, it is determined that the constituent bit of the additional data is [0].

When the parity of the additional data-corresponding recording frame is even parity, and the parity of the additional data-corresponding user control data (UCD) is even parity, it is determined that the constituent bit of the additional data is [1].

When the parity of the additional data-corresponding recording frame is odd parity, and the parity of the additional data-corresponding user control data (UCD) is odd parity, it is determined that the constituent bit of the additional data is [1].

Thus, the reproducing device can determine whether the additional information bit is [0] or [1] on the basis of the data read from the recording medium, that is, the two data characteristics (parities) of the additional data-corresponding recording frame and the additional data-corresponding user control data (UCD).

The additional data decoding unit 408 performs a similar process on the basis of data necessary to decode intermittently input additional data, that is, additional data-corresponding recording frames and additional data-corresponding user control data (UCD). The additional data decoding unit 408 thereby obtains the additional data such for example as key data as n-bit information, key generating information, content reproduction control information, content copy control information, or other content attribute information. Incidentally, this additional data includes an error correcting code as mentioned in the description of the data recording processing device. The additional data is subjected to error correction in the additional data error correcting unit 409, and then output.

Incidentally, when the additional data is key information applied to the decryption of contents, for example, the additional data is output to a decryption processing unit that decrypts the contents. When the additional data is content reproduction control information, the additional data is output to a reproduction controlling unit.

As for general data other than the additional data, the data read from the information recording medium is output from the synchronism detecting unit 406 to the data demodulation processing unit 407. Data conversions reverse to those described above with reference to FIGS. 2A to 3H are sequentially performed, whereby reproduced data is obtained.

As with the additional data, main data as demodulated data includes an error correcting code. The main data is subjected to error correction in the main data error correcting unit 412, and then output.

Incidentally, when the output data is encrypted contents, for example, the output data is subjected to a decrypting process applying an encryption key that can be generated on the basis of key generating information output as the additional data, and then output via outputting means such as a display, a speaker and the like.

A reproduction process sequence including additional information reading will next be described with reference to FIG. 16. The process of FIG. 16 is performed in the reproduction processing device shown in FIG. 15.

In step S201, an RF signal is generated on the basis of a signal read from the information recording medium. In step S202, two data characteristics (parities) based on an additional data-corresponding recording frame before demodulation and additional data-corresponding user control data (UCD) after the demodulation are calculated.

In step S203, it is determined whether the parity of modulated data of the additional data-corresponding recording frame is even parity. When the parity of the modulated data of the additional data-corresponding recording frame is even parity, it is further determined in step S204 whether the parity of the additional data-corresponding user control data (UCD) is even parity. When the parity of the additional data-corresponding user control data (UCD) is even parity, it is determined in step S206 that an additional data bit=1. When the parity of the additional data-corresponding user control data (UCD) is odd parity, it is determined in step S207 that the additional data bit=0.

When it is determined in step S203 that the parity of the modulated data of the additional data-corresponding recording frame is odd parity, it is further determined in step S205 whether the parity of the additional data-corresponding user control data (UCD) is even parity. When the parity of the additional data-corresponding user control data (UCD) is even parity, it is determined in step S207 that the additional data bit=0. When the parity of the additional data-corresponding user control data (UCD) is odd parity, it is determined in step S206 that the additional data bit=1.

In step S208, it is determined whether the additional data bit is a last bit of additional data. When there is an unprocessed bit, the process from step S202 on down is repeated. When the last bit of the additional data is processed, the process is ended.

It is to be noted that while the foregoing embodiment has been described centering on an example using parity information, parity is an example of state information of a data area, and various other detectable state values are applicable. That is, various information other than parity is applicable as long as the information represents a state obtained from data.

In addition, in the above-described embodiment, additional data information is set by setting the parity of user control data (UCD) to even parity or odd parity, the present invention is not limited to user control data (UCD). When there is a bit-adjustable area in another data area, the data area may be set as additional data-corresponding data to be controlled at a time of writing and to be decoded at a time of data reading.

The present invention has been explained above in detail with reference to a specific embodiment thereof. It is obvious, however, that modifications and substitutions in the embodiment may be made by those skilled in the art without departing from the spirit of the present invention. That is, the present invention has been disclosed in a form that is illustrative and is thus not to be construed in a restrictive manner. In order to determine the spirit of the present invention, a section of claims described at the beginning hereof is to be considered.

Incidentally, the series of processes described in the specification can be carried out by hardware or by software or by a composite configuration of both. When the processes are to be carried out by software, a program in which process sequences are recorded can be installed into a memory within a computer incorporated in special hardware, and then executed, or installed onto a general-purpose computer capable of performing various processing, and then executed.

For example, the program can be recorded in advance on a hard disk or in a ROM (Read Only Memory) as a recording medium. Alternatively, the program can be stored (recorded) temporarily or permanently on a removable recording medium such as a flexible disk, a CD-ROM (Compact Disc Read Only Memory), an MO (Magneto Optical) disk, a DVD (Digital Versatile Disc), a magnetic disk, a semiconductor memory or the like. Such removable recording media can be provided as so-called packaged software.

In addition to being installed onto a computer from a removable recording medium as described above, the program can be transferred by radio from a download site to a computer or transferred to a computer by wire via a network such as a LAN (Local Area Network), the Internet or the like. The computer can receive the program thus transferred thereto, and install the program onto a recording medium such as a built-in hard disk or the like.

It is to be noted that the various processes described in the specification may be carried out not only in time series according to the description but also in parallel or individually according to processing capability of an apparatus performing the processes or as required. In the present specification, a system refers to a logical set configuration of a plurality of devices, and each constituent device is not necessarily present within an identical casing.

### INDUSTRIAL APPLICABILITY

As described above, according to a constitution of the present invention, when additional data is recorded onto an information recording medium, or additional information such for example as key information applied to a content decrypting process, key generating information, content reproduction control information, or copy control information is recorded onto the information recording medium, constituent bits of a data-changeable data unit, for example user control data (UCD) are controlled and set according to constituent bit information [0] or [1] of the additional data and a data characteristic of a specific additional data-corresponding recording frame selected. At a time of reproduction, the additional constituent bit information [0] or [1] can be obtained by detecting the data characteristic of the additional data-corresponding recording frame and a data characteristic of the constituent data of the user control data (UCD). With this constitution, additional information such for example as key information applied to a content decrypting process, key generating information, content reproduction control information, or copy control information is embedded in a mode difficult to analyze, and reliably read at a time of reproduction. Thus, the present invention is applicable to an information recording processing device, an information reproduction processing device, and an information recording medium when it is necessary, for example, to store contents whose copyright needs to be protected on the recording medium and embed additional information such for example as key information applied to a process of decrypting the contents, key generating information, content reproduction control information, or copy control information in a mode difficult to analyze.

In addition, according to a constitution of the present invention, in a process of recording additional data, the parity of a data-changeable data unit, for example user control data (UCD) is set to even parity or odd parity by controlling constituent bits of the user control data according to constituent bit information [0] or [1] of the additional data and according to whether the parity of a specific additional data-corresponding recording frame selected is even parity or odd parity. At a time of reproduction, the additional constituent bit information [0] or [1] can be obtained by detecting the parity of the additional data-corresponding recording frame and the parity of the constituent data of the user control data (UCD). With this constitution, additional information such for example as key information applied to a content decrypting process, key generating information, content reproduction control information, or copy control information is embedded in a mode difficult to analyze, and reliably read at a time of reproduction. Thus, the present invention is applicable to an information recording processing device, an information reproduction processing device, and an information recording medium when it is necessary, for example, to store contents whose copyright needs to be protected on the recording medium and embed additional information such for example as key information applied to a process of decrypting the contents, key generating information, content reproduction control information, or copy control information in a mode difficult to analyze.

1. An information recording processing device characterized by comprising:
a modulated data generating unit for generating a modulated recording frame by performing data modulation processing on data to be recorded;
recording frame characteristic determining means for determining a data characteristic of constituent data of an additional data-corresponding recording frame; and
an additional data-corresponding data controlling unit for controlling constituent bits of a data-changeable data part on a basis of a constituent bit value of additional data and the data characteristic of the constituent data of said additional data-corresponding recording frame.

2. The information recording processing device as claimed in claim 1,
wherein in said additional data-corresponding data controlling unit, the data part whose constituent bits are controlled is user control data (UCD).

3. The information recording processing device as claimed in claim 1,
wherein the data characteristic of the constituent data of said additional data-corresponding recording frame is a characteristic of whether parity of the constituent data of the recording frame is even parity or odd parity, and
said additional data-corresponding data controlling unit controls the constituent bits of the data-changeable data part on a basis of two conditions of whether the constituent bit value of said additional data is 0 or 1 and whether the parity of the constituent data of said additional data-corresponding recording frame is even parity or odd parity.

4. The information recording processing device as claimed in claim 1,
wherein said additional data-corresponding data controlling unit performs control to set parity of the data-changeable data part to one of odd parity and even parity.

5. The information recording processing device as claimed in claim 1,
wherein said additional data is set as constituent information of at least one of encryption key information, encryption key generating information, content reproduction control information, and content copy control information for contents stored on said information recording medium.

6. The information recording processing device as claimed in claim 1,
wherein said modulated data generating unit generates the modulated recording frame by performing a data conversion process satisfying RLL (1, 7) as a run length rule.

7. The information recording processing device as claimed in claim 1,
wherein said modulated data generating unit performs a modulated recording frame generating process including a process of conversion of two-bit information into three-bit information.

8. An information reproduction processing device for reproducing information stored on an information recording medium, said information reproduction processing device characterized by comprising:
a demodulating unit for demodulating data read from the information recording medium; and
an additional data decoding unit for determining data characteristics of an additional data-corresponding recording frame and specific user control data read from the information recording medium, and obtaining additional data constituent bit information on a basis of the two determined data characteristics.

9. The information reproduction processing device as claimed in claim 8,
wherein in said additional data decoding unit, a data part whose data characteristic is determined is user control data (UCD).

10. The information reproduction processing device as claimed in claim 8,
wherein the data characteristic of constituent data of said additional data-corresponding recording frame is a characteristic of whether parity of the constituent data of the recording frame is even parity or odd parity, and
said additional data decoding unit obtains the additional data constituent bit information on a basis of two data characteristic determinations of whether the parity of the constituent data of said additional data-corresponding recording frame is even parity or odd parity and whether parity of constituent data of the specific user control data is even parity or odd parity.

11. The information reproduction processing device as claimed in claim 8,
wherein at least one of encryption key information, encryption key generating information, content reproduction control information, and content copy control information for contents stored on said information recording medium is generated on a basis of the obtained additional data constituent bit information.

12. An information recording medium storing:
modulated data based on a plurality of recording frames; and
user control data having a data characteristic determined on a basis of a constituent bit value of additional data and a data characteristic of constituent data of a specific additional data-corresponding recording frame selected from the plurality of recording frames.

13. The information recording medium as claimed in claim 12,
wherein the data characteristic of the constituent data of said additional data-corresponding recording frame is a characteristic of whether parity of the constituent data of the recording frame is even parity or odd parity, and
said user control data has the data characteristic determined according to two conditions of whether the constituent bit value of said additional data is 0 or 1 and whether the parity of the constituent data of said additional data-corresponding recording frame is even parity or odd parity.

14. The information recording medium as claimed in claim 12,
wherein the data characteristic determined for said user control data is a data characteristic of whether parity of constituent data of said user control data is even parity or odd parity, and
the user control data having the parity determined on a basis of the constituent bit value of said additional data and the data characteristic of the constituent data of the specific additional data-corresponding recording frame selected from said plurality of recording frames is stored.

15. The information recording medium as claimed in claim 12,
wherein said additional data is stored as constituent information of at least one of encryption key information, encryption key generating information, content reproduction control information, and content copy control information for contents stored on said information recording medium.

16. The information recording medium as claimed in claim 12,
wherein the data based on a modulated recording frame generated by performing a data conversion process satisfying RLL (1, 7) as a run length rule is recorded.

17. The information recording medium as claimed in claim 12,
wherein the data based on a modulated recording frame generated by performing a process of converting two-bit information into three-bit information is recorded.

18. An information recording processing method comprising:
an additional data-corresponding data controlling step of controlling constituent bits of a data-changeable data part on a basis of a constituent bit value of additional data and a data characteristic of constituent data of an additional data-corresponding recording frame; and
a modulated data generating step of generating a modulated recording frame by performing data modulation processing on data to be recorded.

19. The information recording processing method as claimed in claim 18,
wherein in said additional data-corresponding data controlling step, the data part whose constituent bits are controlled is user control data (UCD).

20. The information recording processing method as claimed in claim 18,
wherein the data characteristic of the constituent data of said additional data-corresponding recording frame is a characteristic of whether parity of the constituent data of the recording frame is even parity or odd parity, and
said additional data-corresponding data controlling step controls the constituent bits of the data-changeable data part on a basis of two conditions of whether the constituent bit value of said additional data is 0 or 1 and whether the parity of the constituent data of said additional data-corresponding recording frame is even parity or odd parity.

21. The information recording processing method as claimed in claim 18,
wherein said additional data-corresponding data controlling step performs control to set parity of the data-changeable data part to one of odd parity and even parity.

22. The information recording processing method as claimed in claim 18,
wherein said additional data is constituent information of at least one of encryption key information, encryption key generating information, content reproduction control information, and content copy control information for contents stored on said information recording medium.

23. The information recording processing method as claimed in claim 18,
wherein said modulated data generating step generates the modulated recording frame by performing a data conversion process satisfying RLL (1, 7) as a run length rule.

24. The information recording processing method as claimed in claim 18,
wherein said modulated data generating step performs a modulated recording frame generating process including a process of conversion of two-bit information into three-bit information.

25. An information reproduction processing method for reproducing information stored on an information recording medium, said information reproduction processing method characterized by comprising:
a demodulating step of demodulating data read from the information recording medium; and
an additional data decoding step of determining data characteristics of an additional data-corresponding recording frame and specific user control data read from the information recording medium, and obtaining additional data constituent bit information on a basis of the two determined data characteristics.

26. The information reproduction processing method as claimed in claim 25,
wherein in said additional data decoding step, a data part whose data characteristic is determined is user control data (UCD).

27. The information reproduction processing method as claimed in claim 25,
wherein the data characteristic of constituent data of said additional data-corresponding recording frame is a characteristic of whether parity of the constituent data of the recording frame is even parity or odd parity, and
said additional data decoding step obtains the additional data constituent bit information on a basis of two data characteristic determinations of whether the parity of the constituent data of said additional data-corresponding recording frame is even parity or odd parity and whether parity of constituent data of the specific user control data is even parity or odd parity.

28. The information reproduction processing method as claimed in claim 25, further comprising a step of generating at least one of encryption key information, encryption key generating information, content reproduction control information, and content copy control information for contents stored on said information recording medium on a basis of the obtained additional data constituent bit information.

29. A computer program for performing an information recording process, said computer program comprising:
an additional data-corresponding data controlling step of controlling constituent bits of a data-changeable data part on a basis of a constituent bit value of additional data and a data characteristic of constituent data of an additional data-corresponding recording frame; and
a modulated data generating step of generating a modulated recording frame by performing data modulation processing on data to be recorded.

30. A computer program for reproducing information stored on an information recording medium, said computer program comprising:
a demodulating step of demodulating data read from the information recording medium; and
an additional data decoding step of determining data characteristics of an additional data-corresponding recording frame and specific user control data read from the information recording medium, and obtaining additional data constituent bit information on a basis of the two determined data characteristics.
